(19) United States
(12) Patent Application Publication
(10) Pub. No.: US 2016/0344325 A1
(43) Pub. Date: Nov. 24, 2016

(54) CONTROL CIRCUIT FOR FAN AND ELECTRONIC SYSTEM UTILIZING SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JIN-SHAN MA, Shenzhen (CN); WU ZHOU, Shenzhen (CN)

(21) Appl. No.: 14/805,126

(22) Filed: Jul. 21, 2015

(30) Foreign Application Priority Data
May 18, 2015 (CN) 201510251832.5

(51) Int. Cl. H02P 7/29

(52) U.S. Cl. CPC H02P 7/2913; H02P 7/29

(57) ABSTRACT

A control circuit for a fan of an electronic system includes a temperature sensor detecting temperature in the electronic system, a connector electrically coupled to the fan, and a control chip electrically coupled to the temperature sensor and the connector to obtain instant temperature and rotational speed. Through the connector, the control chip outputs a first pulse width modulation (PWM) signal configured to adjust duty ratio of the first PWM signal. An amplitude adjustment unit electrically coupled to the control chip is configured to adjust amplitude of the first PWM signal to output a second PWM signal, and an inverting unit electrically coupled to the connector and the amplitude adjustment unit reverses the second PWM signal to output a third PWM signal to the fan, through the connector, to control the rotational speed of the fan.

### FIELD

The subject matter herein generally relates to a control circuit and an electronic system.

### BACKGROUND

Fans are widely used in electronic systems, such as server systems, for heat dissipation. When enabled, the fans generally run at one speed which is the maximum speed.

### BRIEF DESCRIPTION OF THE DRAWINGS

Implementations of the present technology will now be described, by way of example only, with reference to the attached figures.

FIG. 1 is a block diagram of an embodiment of an electronic system comprising a control circuit.

FIG. 2 is a circuit diagram of the control circuit of FIG.1, wherein the control circuit comprises a control chip, an amplitude adjustment unit, and an inverting unit.

FIG. 3 is a waveform diagram of a first pulse width modulation (PWM) signal outputted by the control chip of FIG. 2, wherein the voltage of the first PWM signal is high level.

FIG. 4 is a waveform diagram of a second PWM signal outputted by the inverting unit of FIG. 2, wherein the voltage of the first PWM signal is high level.

FIG. 5 is a waveform diagram of a third PWM signal outputted by the amplitude adjustment unit of FIG. 2, wherein the voltage of the first PWM signal is low level.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to an electronic system capable of outputting pulsed voltages of different amplitudes.

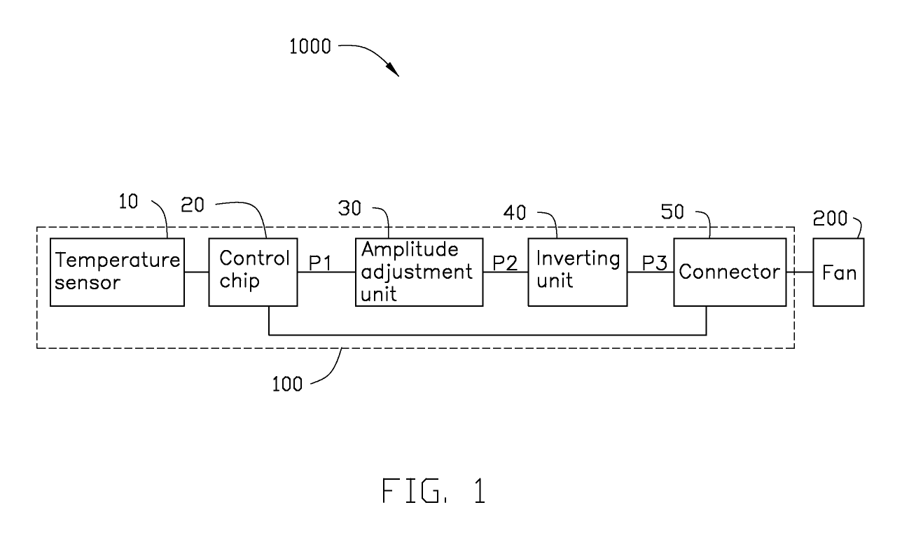

FIG. 1 illustrates that an embodiment of an electronic system 1000 comprises a fan 200 and a control circuit 100 for the fan 200.

The control circuit 100 comprises a temperature sensor 10, a control chip 20, an amplitude adjustment unit 30, an inverting unit 40, and a connector 50. The control chip 20 is electrically coupled between the temperature sensor 10 and the connector 50. The control chip 20 is further electrically coupled to the connector 50 through the amplitude adjustment unit 30 and the inverting unit 40 in sequence. The connector 50 is electrically coupled to the fan 200. In use, the control chip 20 outputs a first pulse width modulation (PWM) signal P1 to the amplitude adjustment unit 30. The amplitude adjustment unit 30 adjusts amplitude of the first PWM signal P1 to output a second PWM signal P2 to the inverting unit 40. The inverting unit 40 reverses the second PWM signal P2 to output a third PWM signal P3 to the fan 200 through the connector 50, for controlling rotational speed of the fan 200. The control chip 20 further obtains instant temperature in the electronic system 1000 from the temperature sensor 10 and instant rotational speed of the fan 200 through the connector 50, to enable adjustment of the duty ratio of the first PWM signal P1 to the fan 200. In at least one embodiment, the control chip 20 is a complex programmable logic device (CPLD) core.

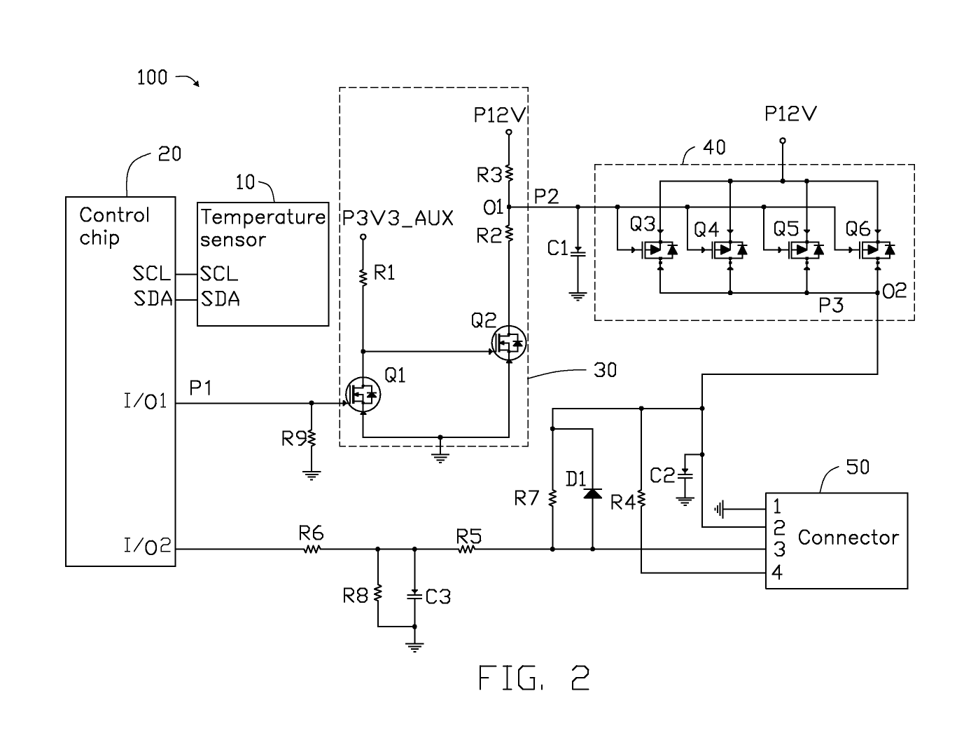

FIG. 2 illustrates the temperature sensor 10, the control chip 20, the amplitude adjustment unit 30, the inverting unit 40, and the connector 50 in a circuit. The temperature sensor 10 comprises a serial clock pin SCL and a serial data pin SDA.

The control chip 20 comprises a serial clock pin SCL, a serial data pin SDA, an output pin I/O1, and an input pin I/O2. The serial clock pin SCL of the temperature sensor 10 is electrically coupled to the serial clock pin SCL of the control chip 20, and the serial data pin SDA of the temperature sensor 10 is electrically coupled to the serial data pin SDA of the control chip 20. The control chip 20 can thus obtain an instant temperature in the electronic system from the temperature sensor 10.

The amplitude adjustment unit 30 comprises two electronic switches Q1 and Q2 each comprising a first terminal, a second terminal, and a third terminal. The first terminal of the electronic switch Q1 is electrically coupled to the output pin I/O1 of the control chip 20 to obtain the first PWM signal P1 from the control chip 20, and is further grounded through a resistor R9. The second terminal of the electronic switch Q1 is grounded. The third terminal of the electronic switch Q1 is electrically coupled to a voltage source P3V3_AUX through a resistor R1. The first terminal of the electronic switch Q2 is electrically coupled to the third terminal of the electronic switch Q1. The second terminal of the electronic switch Q2 is grounded. The third terminal of the electronic switch Q2 is electrically coupled to a voltage source P12V, through resistor R2 and resistor R3 in sequence. The inverting unit 40 is electrically coupled to a node between the resistor R2 and the resistor R3 which is an output terminal O1 of the amplitude adjustment unit 30, to obtain the second PWM signal P2 from the output terminal O1 of the amplitude adjustment unit 30. In at least one embodiment, the electronic switch Q1 and the electronic switch Q2 are n-channel metal-oxide semiconductor field-effect transistors (NMOSFETs). The voltage of the voltage source P12V is 12V.

The inverting unit 40 comprises four electronic switches Q3-Q6 each comprising a first terminal, a second terminal, and a third terminal. The first terminals of the four electronic switches Q3-Q6 are electrically coupled to the output terminal O1 of the amplitude adjustment unit 30 and are further grounded through a capacitor C1. The second terminals of the four electronic switches Q3-Q6 are electrically coupled to the voltage source P12V. The third terminals of the four electronic switches Q3-Q6, as an output terminal O2 of the inverting unit 40, are electrically coupled to the connector 50, to output the third PWM signal P3 to the connector 50. In at least one embodiment, the four electronic switches Q3-Q6 are p-channel metal-oxide semiconductor field-effect transistors (PMOSFETs).

The connector 50 comprises a grounding pin 1, a power supply pin 2, a detecting pin 3, and a control pin 4. The grounding pin 1 is grounded. The power supply pin 2 is electrically coupled to the output terminal O2 of the inverting unit 40 and is further grounded through a capacitor C2. The detecting pin 3 is electrically coupled to a positive pole of a diode D1. The detecting pin 3 is further electrically coupled to the output terminal O2 of the inverting unit 40 through a resistor R7. The detecting pin 3 is also electrically coupled to the input pin I/O2 of the control chip 20 through two resistors R5 and R6, for the control chip 20 to obtain the instant rotational speed of the fan 200 through the connector 50. A negative pole of the diode D1 is electrically coupled to the output terminal O2 of the inverting unit 40. A node between the two resistors R5 and R6 is grounded through a capacitor C3 and is further grounded through a resistor R8. The control pin 4 is electrically coupled to the output terminal O2 of the inverting unit 40 through a resistor R4.

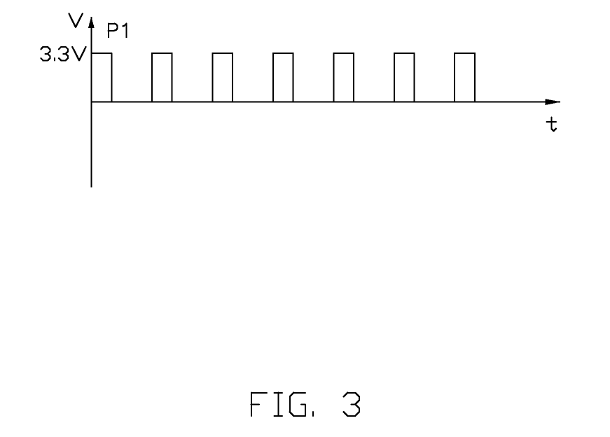

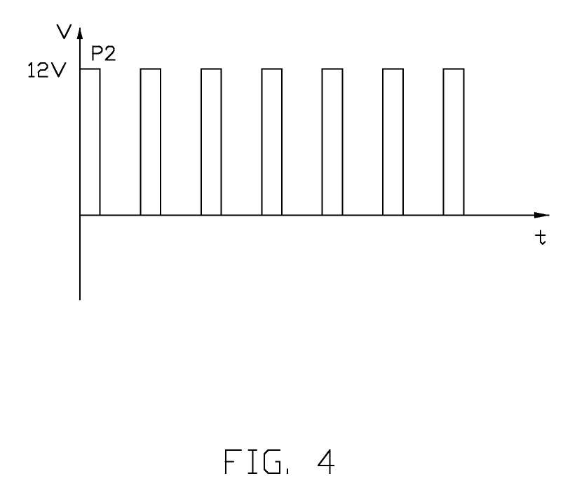

Referring to FIGS. 3 and 4, when the voltage of the first PWM signal P1 is high level, such as 3.3V, the electronic switch Q1 is turned on and the third terminal of the electronic switch Q1 outputs a low level signal to the first terminal of the electronic switch Q2. The electronic switch Q2 is turned off. The output terminal O1 of the amplitude adjustment unit 30 outputs the high level second PWM signal P2 (of which the voltage is 12V) to the first terminals of the four electronic switches Q3-Q6. The four electronic switches Q3-Q6 are turned off and the output terminal O2 of the inverting unit 40 outputs the low level third PWM signal P3 to the connector 50 to stop the fan 200.

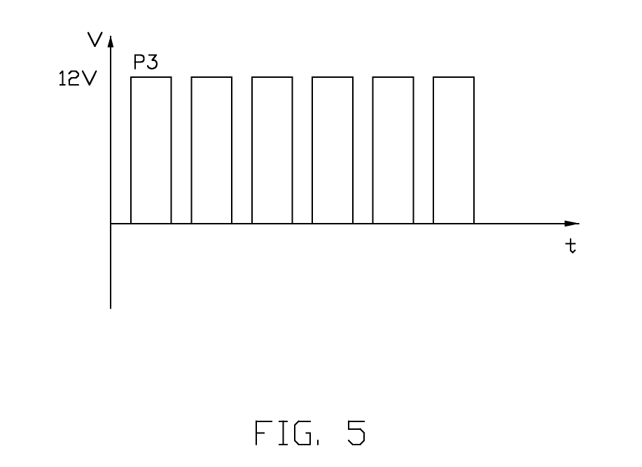

Referring to FIG. 5, when the voltage of the first PWM signal P1 is low level, the electronic switch Q1 is turned off and the third terminal of the electronic switch Q1 outputs a high level signal to the first terminal of the electronic switch Q2. The electronic switch Q2 is turned on. The output terminal O1 of the amplitude adjustment unit 30 outputs the low level second PWM signal P2 to the first terminals of the four electronic switches Q3-Q6. The four electronic switches Q3-Q6 are turned on and the output terminal O2 of the inverting unit 40 outputs the high level third PWM signal P3 (of which the voltage is 12V) to the connector 50 to operate the fan 200.

The embodiments shown and described above are only examples. Many details are often found in the art such as the other features of a control circuit and an electronic system. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A control circuit comprising:
a temperature sensor configured to detect temperature in an electronic system;
a connector configured to be electrically coupled to a fan of the electronic system;
a control chip electrically coupled to the temperature sensor and the connector, the control chip configured to output a first pulse width modulation (PWM) signal, and the control chip configured to obtain the temperature in the electronic system and rotational speed of the fan to adjust a duty ratio of the first PWM signal;
an amplitude adjustment unit electrically coupled to the control chip and configured to adjust an amplitude of the first PWM signal to output a second PWM signal; and
an inverting unit electrically coupled to the connector and the amplitude adjustment unit, the inverting unit configured to reverse the second PWM signal to output a third PWM signal to the connector to control the rotational speed of the fan.

2. The control circuit of claim 1, wherein the control chip is a complex programmable logic device (CPLD) core.

3. The control circuit of claim 2, wherein the temperature sensor comprises a serial clock pin and a serial data pin, and the control chip comprises a serial clock pin electrically coupled to the serial clock pin of the temperature sensor and a serial data pin electrically coupled to the serial data pin of the temperature sensor.

4. The control circuit of claim 1, wherein the control chip comprises an output pin configured to output the first PWM signal, the amplitude adjustment unit comprises a first electronic switch and a second electronic switch, a first terminal of the first electronic switch is electrically coupled to the output pin of the control chip to obtain the first PWM signal from the control chip, a second terminal of the first electronic switch is grounded, a third terminal of the first electronic switch is electrically coupled to a first voltage source through a first resistor, a first terminal of the second electronic switch is electrically coupled to the third terminal of the first electronic switch, a second terminal of the second electronic switch is grounded, a third terminal of the second electronic switch is electrically coupled to a second voltage source through a second resistor and a third resistor in sequence, and the inverting unit is electrically coupled to a node between the second resistor and the third resistor which is an output terminal of the amplitude adjustment unit to obtain the second PWM signal from the output terminal of the amplitude adjustment unit.

5. The control circuit of claim 4, wherein the inverting unit comprises at least one electronic switch, a first end of the at least one electronic switch is electrically coupled to the output terminal of the amplitude adjustment unit, a second terminal of the at least one electronic switch is electrically coupled to the second voltage source, and a third terminal of the at least one electronic switch, as an output terminal of the inverting unit, is electrically coupled to the connector.

6. The control circuit of claim 5, wherein the connector comprises a grounding pin, a power supply pin, a detecting pin, and a control pin, the control chip further comprises an input pin, the grounding pin is grounded, the power supply pin is electrically coupled to the output terminal of the inverting unit, and the detecting pin is electrically coupled to the input pin, the control pin is electrically coupled to the output terminal of the inverting unit.

7. The control circuit of claim 6, wherein the detecting pin is electrically coupled to the input pin of the control chip through a fifth resistor and a sixth resistor, the detecting pin is electrically coupled to the output terminal of the inverting unit through a seventh resistor, the detecting pin is electrically coupled to a positive pole of a diode, and a negative pole of the diode electrically coupled to the output terminal of the inverting unit, and a node between the fifth resistor and the sixth resistor is grounded through a capacitor and is further grounded through an eighth resistor.

8. An electronic system comprising:
a fan;
a control circuit to control rotational speed of the fan and comprising:
a temperature sensor configured to detect temperature in the electronic system;
a connector electrically coupled to the fan;
a control chip electrically coupled to the temperature sensor and the connector, the control chip configured to output a first pulse width modulation (PWM) signal, and the control chip configured to obtain the temperature in the electronic system and the rotational speed of the fan to adjust a duty ratio of the first PWM signal;
an amplitude adjustment unit electrically coupled to the control chip and configured to adjust an amplitude of the first PWM signal and output a second PWM signal; and
an inverting unit electrically coupled to the connector and the amplitude adjustment unit and configured to reverse the second PWM signal to output a third PWM signal to the connector to control the rotational speed of the fan.

9. The electronic system of claim 8, wherein the control chip is a complex programmable logic device (CPLD) core.

10. The electronic system of claim 9, wherein the temperature sensor comprises a serial clock pin and a serial data pin, and the control chip comprises a serial clock pin electrically coupled to the serial clock pin of the temperature sensor and a serial data pin electrically coupled to the serial data pin of the temperature sensor, for the control chip obtaining the temperature in the electronic system from the temperature sensor.

11. The electronic system of claim 8, wherein the control chip comprises an output pin configured to output the first PWM signal, the amplitude adjustment unit comprises a first electronic switch and a second electronic switch, a first terminal of the first electronic switch is electrically coupled to the output pin of the control chip to obtain the first PWM signal from the control chip, a second terminal of the first electronic switch is grounded, a third terminal of the first electronic switch is electrically coupled to a first voltage source through a first resistor, a first terminal of the second electronic switch is electrically coupled to the third terminal of the first electronic switch, a second terminal of the second electronic switch is grounded, a third terminal of the second electronic switch is electrically coupled to a second voltage source through a second resistor and a third resistor in sequence, the inverting unit is electrically coupled to a node between the second resistor and the third resistor as an output terminal of the amplitude adjustment unit to obtain the second PWM signal from the output terminal of the amplitude adjustment unit.

12. The electronic system of claim 11, wherein the inverting unit comprises at least one electronic switch, a first end of the at least one electronic switch is electrically coupled to the output terminal of the amplitude adjustment unit, a second terminal of the at least one electronic switch is electrically coupled to the second voltage source, and a third terminal of the at least one electronic switch, as an output terminal of the inverting unit, is electrically coupled to the connector.

13. The electronic system of claim 12, wherein the connector comprises a grounding pin, a power supply pin, a detecting pin, and a control pin, the control chip further comprises an input pin, the grounding pin is grounded, the power supply pin is electrically coupled to the output terminal of the inverting unit, and the detecting pin is electrically coupled to the input pin, the control pin is electrically coupled to the output terminal of the inverting unit.

14. The electronic system of claim 13, wherein the detecting pin is electrically coupled to the input pin of the control chip through a fifth resistor and a sixth resistor, the detecting pin is electrically coupled to the output terminal of the inverting unit through a seventh resistor, the detecting pin is electrically coupled to a positive pole of a diode, and a negative pole of the diode electrically coupled to the output terminal of the inverting unit, and a node between the fifth resistor and the sixth resistor is grounded through a capacitor and is further grounded through an eighth resistor.
